(19) United States
(12) Patent Application Publication
(10) Pub. No.: US 2019/0008018 A1
(43) Pub. Date: Jan. 3, 2019

(54) METHOD AND APPARATUS FOR CONTROLLING SMART FLASHLIGHT AND SMART DEVICE

(71) Applicant: Beijing Xiaomi Mobile Software Co., Ltd., Beijing (CN)

(72) Inventor: Yan Xie, Beijing (CN)

(73) Assignee: Beijing Xiaomi Mobile Software Co., Ltd., Beijing (CN)

(21) Appl. No.: 16/010,287

(22) Filed: Jun. 15, 2018

(30) Foreign Application Priority Data
Jun. 30, 2017 (CN) 201710525257.2

(51) Int. Cl. H05B 37/02

(52) U.S. Cl. CPC H05B 37/0227; G08B 3/10

(57) ABSTRACT

The present disclosure discloses a method and a smart device. The method includes obtaining a direction signal indicative of a present moving direction of the smart device when the smart device is in a first working mode. The method also includes determining, by the processing circuitry of the smart device, a present illumination configuration corresponding to the present moving direction based on a pre-defined relationship between the moving direction and the illumination configuration. Further, the method includes illuminating with the smart device according to the present illumination configuration to indicate the present moving direction.

### CROSS REFERENCE TO RELATED APPLICATION

This application is based upon and claims a priority to Chinese Patent Application No. 201710525257.2, filed on Jun. 30, 2017, the entire contents of which are incorporated herein by reference.

### TECHNICAL FIELD

The present disclosure relates to a field of smart appliance technology, and more particularly, to a method and an apparatus for controlling a smart flashlight and a smart device.

### BACKGROUND

It is easy to get lost when a user walks on an unfamiliar road or in the open country without sufficient landmarks at night, leading to a potential safety risk for the user and delaying the user's journey.

In related arts, a lot of smart devices are equipped with a compass function. However, in a case of low light at night, it is inconvenient for the user to check the compass again and again. For example, the user may not concentrate on the road condition, and content of the compass cannot be seen clearly due to the low light.

### SUMMARY

This Summary is provided to introduce a selection of aspects of the present disclosure in a simplified form that are further described below in the Detailed Description. This Summary is not intended to identify key features or essential features of the claimed subject matter, nor is it intended to be used to limit the scope of the claimed subject matter.

Aspects of the disclosure provide a method. The method includes obtaining a direction signal indicative of a present moving direction of the smart device when the smart device is in a first working mode. The method also includes determining, by the processing circuitry of the smart device, a present illumination configuration corresponding to the present moving direction based on a pre-defined relationship between the moving direction and the illumination configuration. Further, the method includes illuminating with the smart device according to the present illumination configuration to indicate the present moving direction.

According to an aspect of the disclosure, the method further includes obtaining the pre-defined relationship that is stored in a memory of the smart device.

According to aspects of the disclosure, determining the present illumination configuration corresponding to the present moving direction includes obtaining the pre-defined relationship between the moving direction and the illumination configuration including a light wavelength and determining a present light wavelength corresponding to the present moving direction based on the pre-defined relationship. Further, illuminating with the smart device includes using the present light wavelength.

According to aspects of the disclosure, determining the present illumination configuration corresponding to the present moving direction includes obtaining the pre-defined relationship between the moving direction and the illumination configuration including a light wavelength and a strobe frequency that are associated with strobe lighting. Further, determining the present illumination configuration corresponding to the present moving direction includes determining a present light wavelength and a present strobe frequency corresponding to the present moving direction based on the pre-defined relationship. In addition, illuminating with the smart device includes using the strobe lighting based on the present light wavelength and the present strobe frequency.

According to aspects of the disclosure, the method includes obtaining the pre-defined relationship between the moving direction and the illumination configuration including a light wavelength and a light brightness. The method also includes determining a present light wavelength and a present light brightness corresponding to the present moving direction based on the pre-defined relationship. Further, illuminating with the smart device includes using the present light wavelength and the present light brightness.

According to aspects of the disclosure, the method includes determining a next moving direction when the moving direction is determined to deviate from the present moving direction. The method also includes determining a next illumination configuration corresponding to the next moving direction based on the pre-defined relationship between the moving direction and the illumination configuration. Further, the method includes illuminating with the smart device according to the next illumination configuration.

According to aspects of the disclosure, the method includes detecting an operation by a user of the smart device to select one of working modes of the smart device, and activating the first working mode when the one of operational modes is the first working mode.

According to aspects of the disclosure, the method includes determining whether a present time associated with the smart device satisfies a preset time condition, and when the present time satisfies the preset time condition, activating the first working mode.

According to aspects of the disclosure, the method includes when the moving direction is determined to deviate from the present moving direction, outputting an audio signal alerting a user of the smart device of a change in the moving direction.

Aspects of the disclosure provide a smart device. The smart device includes processing circuitry and a memory. The processing circuitry is configured to obtain a direction signal indicative of a present moving direction of the smart device when the smart device is in a first working mode. The processing circuitry is also configured to determine a present illumination configuration corresponding to the present moving direction based on a pre-defined relationship between the moving direction and the illumination configuration. The processing circuitry is configured to illuminate with the smart device according to the present illumination configuration to indicate the present moving direction. The memory is configured to store instructions executable by the processing circuitry.

Aspects of the disclosure provide a non-transitory computer-readable storage medium storing a program executable by a processor. The program performs obtaining a direction signal indicative of a present moving direction of the smart device when the smart device is in a first working mode. The program also performs determining a present illumination configuration corresponding to the present moving direction based on a pre-defined relationship between the moving direction and the illumination configuration, and illuminating with the smart device according to the present illumination configuration to indicate the present moving direction.

It is to be understood that both the foregoing general description and the following detailed description are illustrative and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1A is a flow chart of a method for controlling a smart flashlight according to an embodiment of the disclosure;

FIG. 1B is a schematic diagram illustrating a scene in which a method for controlling a smart flashlight is applied according to an embodiment of the disclosure;

FIG. 2A is a flow chart of a method for controlling a smart flashlight according to an embodiment of the disclosure;

FIG. 2B is a schematic diagram illustrating a scene in which a method for controlling a smart flashlight is applied according to an embodiment of the disclosure;

FIG. 3 is a flow chart of a method for controlling a smart flashlight according to an embodiment of the disclosure;

FIG. 4 is a flow chart of a method for controlling a smart flashlight according to an embodiment of the disclosure;

FIG. 5 is a flow chart of a method for controlling a smart flashlight according to an embodiment of the disclosure;

FIG. 6 is a flow chart of a method for controlling a smart flashlight according to an embodiment of the disclosure;

FIG. 7 is a block diagram of an apparatus for controlling a smart flashlight according to an embodiment of the disclosure;

FIG. 8 is a block diagram of an apparatus for controlling a smart flashlight according to an embodiment of the disclosure;

FIG. 9 is a block diagram of an apparatus for controlling a smart flashlight according to an embodiment of the disclosure;

FIG. 10 is a block diagram of an apparatus for controlling a smart flashlight according to an embodiment of the disclosure;

FIG. 11 is a block diagram of an apparatus for controlling a smart flashlight according to an embodiment of the disclosure;

FIG. 12 is a block diagram of an apparatus for controlling a smart flashlight according to an embodiment of the disclosure;

FIG. 13 is a block diagram of an apparatus for controlling a smart flashlight according to an embodiment of the disclosure; and

FIG. 14 is a block diagram of a control device applicable to a smart flashlight according to an embodiment of the disclosure.

The specific aspects of the present disclosure, which have been illustrated by the accompanying drawings described above, will be described in detail below. These accompanying drawings and description are not intended to limit the scope of the present disclosure in any manner, but to explain the concept of the present disclosure to those skilled in the art via referencing specific aspects.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

Terms used in the application are intended not to limit the application but only to describe specific embodiments. “A”, “said” and “the” used in a singular form in the application and the appended claims are also intended to include a plural form, unless other meanings are clearly represented in the context. It should also be understood that term “and/or” used in the present disclosure refers to and includes any or all possible combinations of one or more associated items which are listed.

It should be understood that, although terms first, second, third and the like may be adopted to describe various kinds of information in the application, the information should not be limited to these terms. These terms are only adopted to distinguish information of the same type. For example, without departing from the scope of the application, first information may also be called as second information, and similarly, second information may also be called as first information. It depends on the context. For example, word “if” used herein may be explained to be “while” or “when” or “in response to determination”.

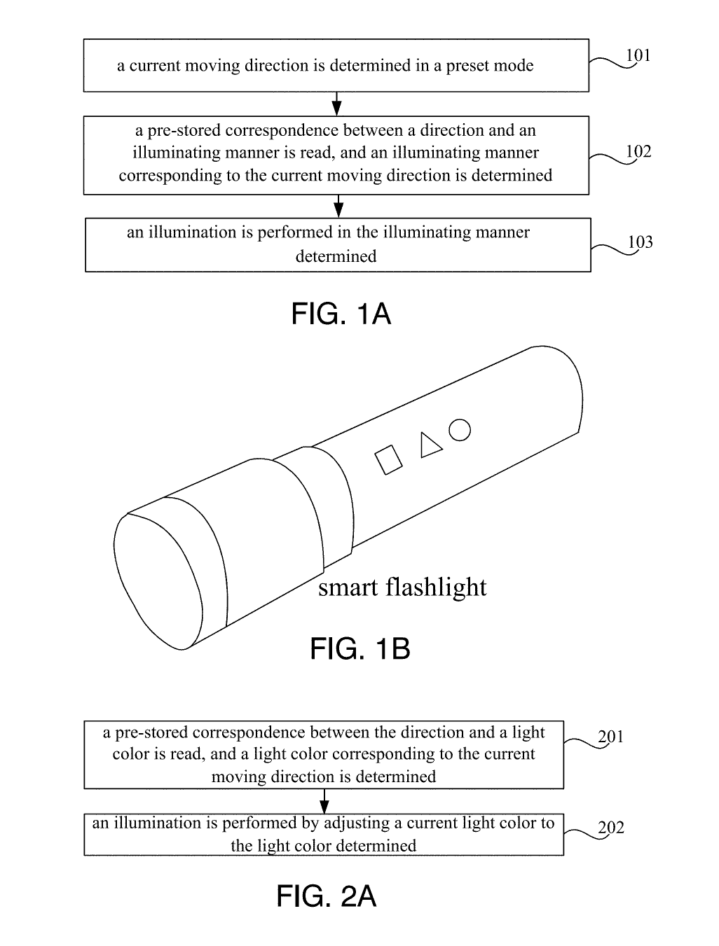

FIG. 1A is a flow chart of a method for controlling a smart flashlight according to an example embodiment. FIG. 1B is a schematic diagram illustrating a scene in which a method for controlling a smart flashlight is applied according to an example embodiment. The method for controlling a smart flashlight may be applied to the smart flashlight. The smart flashlight described herein has a compass function.

The compass function may be implemented by an electronic compass or an anti-interference electronic compass consisting of the electronic compass, a gravity accelerometer and a gyroscope. The compass function has been applied to a smart phone widely, the implementation principle of which will not be described herein. The anti-interference electronic compass consisting of the electronic compass, the gravity accelerometer and the gyroscope has a strong capacity of resisting interference and is sensitive to a direction changing. Alternatively, the compass function may be realized in a smart flashlight according to a real compass. Therefore, those skilled in the art may understand that any implementation for realizing the compass function falls into the scope of the present disclosure.

Referring to FIG. 1A, the method for controlling the smart flashlight may include followings.

At step 101, a current moving direction (or a present moving direction) is determined in a preset mode (or a first working mode). In an example, a directional signal indicative of the current moving direction of the smart flashlight is determined in the preset mode, for example, by processing circuitry of the smart flashlight.

In an embodiment, the smart flashlight may determine the current moving direction such as north, east, south, west, southeast and northwest via a self-contained compass function in a preset mode.

In an embodiment, the preset mode may be selected by the user via a setting function of the smart flashlight.

In an embodiment, the smart flashlight may have time function and date function, in which a time threshold may be preset. For example, in summer, the time threshold may be set as 20:00, in spring and autumn, the time threshold may be set as 19:00, and in winter, the time threshold may be set as 18:00. Once the time threshold is reached, the preset mode is activated automatically. For example, in summer, once the time point 20:00 is passed, the preset mode is activated automatically.

At step 102, a pre-stored correspondence (or a pre-defined relationship) between a direction (or a moving direction) and an illuminating manner (or an illumination configuration) is read, and an illuminating manner corresponding to the current moving direction is determined. In an example, a present illuminating manner corresponding to the current moving direction can be determined by the processing circuitry of the smart flashlight based on a pre-stored relationship between the direction and the illuminating manner. In an example, the pre-stored relationship can be stored in memory of the smart flashlight.

In an embodiment, the illuminating manner may include a color of light (or a light wavelength). Different directions correspond to different colors. For example, east corresponds to yellow, west corresponds to cyan, south corresponds to green and north corresponds to red. Further, the direction may be divided. Southeast corresponds to olivine, southwest corresponds to blue, northeast corresponds to orange and northwest corresponds to violet. The colors of light corresponding to each direction may be personalized, such as based on personal preference and habit.

In an embodiment, the illuminating manner may include a brightness of light (or a light brightness) such as high light and medium light. In addition, the color and the brightness of light may be combined. For example, east may correspond to the color of red and the brightness of medium light.

In an embodiment, the illuminating manner may include a lighting manner such as high-frequency flashing, low-frequency flashing and the like. In an example, the lighting manner can be strobe lighting at a strobe frequency. In addition, the color of light and the lighting manner may be combined. For example, east may correspond to the color of red and the lighting manner of low-frequency flashing.

At step 103, an illumination is performed in the illuminating manner determined.

In an embodiment, the smart flashlight illuminates in the illuminating manner determined at last step. For example, when the current moving direction is east, the color of the light emitted by the smart flashlight is adjusted to red.

In an example scene, as shown in FIG. 1B, take a smart flashlight configured with a compass as an example. The smart flashlight configured as a smart device is included in the scene shown in FIG. 1B, in which the smart flashlight is configured with a compass.

The smart flashlight reads time information, which is 20:01 on Jun. 22, 2017. After that, the smart flashlight reads the time threshold, which is 20:00. The current time is beyond the time threshold, the preset mode is activated, and the compass function of the smart flashlight is enabled. The current moving direction is determined as southwest, the pre-stored correspondence between the preset direction and the light color is read and it is determined that southwest corresponds to the light color of yellow, such that the color of the current light is adjusted as yellow.

In an embodiment, the method for controlling the smart flashlight may further include: when the current moving direction is changed, determining a changed direction; determining an illuminating manner corresponding to the changed direction; and adjusting a current illuminating manner to the illuminating manner corresponding to the changed direction.

In an embodiment, the method for controlling the smart flashlight may further include: when the current moving direction is changed, outputting a speech (or an audio signal) prompt to prompt the user that the current moving direction is changed.

Regarding the specific manner for controlling the smart flashlight, reference can be made to following embodiments.

Therefore, with the method for controlling the smart flashlight described in embodiments of the present disclosure, in a case of low light, the illumination function may be provided to the user and a direction can be directed for the user at the same time. Once the direction deviates from the original direction, the illuminating manner may be changed to prompt the user to adjust the moving direction in time, such that the user needs not to check a compass frequently, thereby avoiding getting lost and providing a convenient and optimized solution.

Technical solutions provided by embodiments of the present disclosure will be described in detail below with reference to specific embodiments.

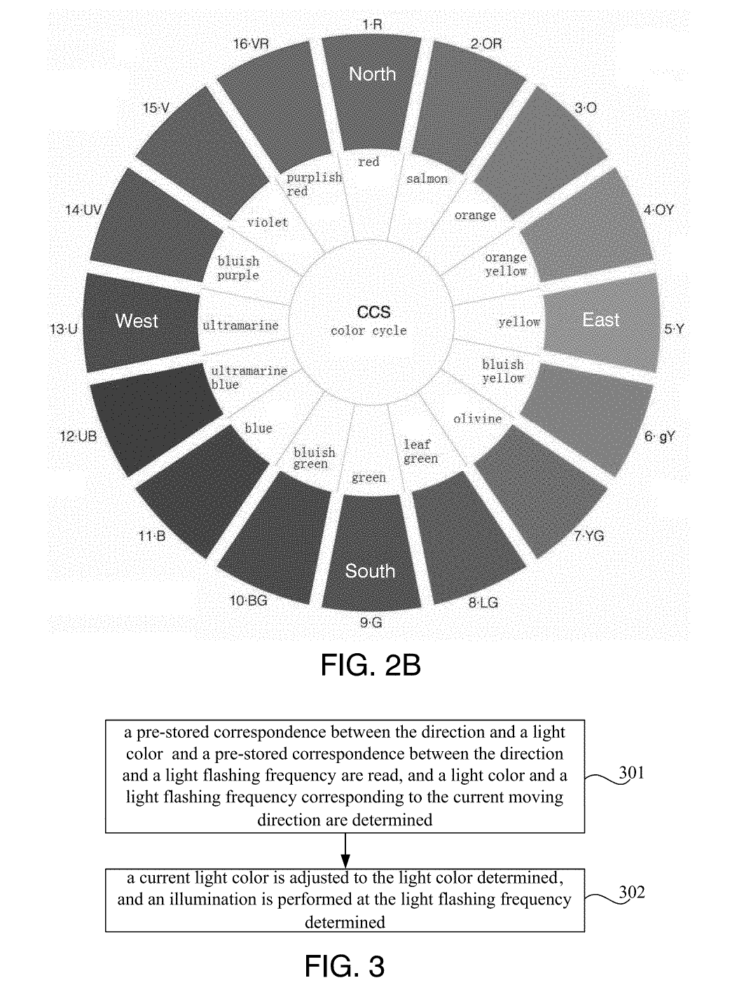

FIG. 2A is a flow chart of a method for controlling a smart flashlight according to another example embodiment. Based on the method provided by the above embodiments of the present disclosure, this embodiment is discussed exemplarily by taking a process of determining an illuminating manner corresponding to the current direction by reading a pre-stored correspondence between the direction and the illuminating manner will be discussed as an example and referring to FIG. 2B. As shown in FIG. 2A, the method may include followings.

At step 201, a pre-stored correspondence between the direction and a light color is read, and a light color corresponding to the current moving direction is determined.

In an embodiment, the pre-stored correspondence between the direction and the light color is stored in the smart flashlight. For example, east may correspond to yellow, southwest may correspond to blue, north may correspond to red and so on as shown in FIG. 2B. The smart flashlight is able to determine the light color corresponding to the current direction by checking the pre-stored correspondence based on the current moving direction.

At step 202, an illumination is performed by adjusting a current light color to the light color determined.

In an embodiment, if the current light color is different from the light color determined, the current light color is adjusted to the light color determined. If the current light color is same as the light color determined, no adjustment needs to be made on the current light color.

In an example scene, as shown in FIG. 2B, the direction may be divided into 16 directions corresponding respectively to different colors. For example, when the current moving direction is east, the color corresponding to east is determined as yellow, and when the current moving direction is south, the color corresponding to south is determined as green, such that the light color may be changed when the current moving direction is changed.

In this embodiment, by implementing acts 201-202, the light color corresponding to the current moving direction can be determined according to the preset correspondence between the direction and the light color, such that when the moving direction is changed, the light color can be changed in time, so as to provide an accurate prompt to the user for preventing the user from going in a wrong direction or getting lost.

FIG. 3 is a flow chart of a method for controlling a smart flashlight according to yet another example embodiment. Based on the method provided by the above embodiments of the present disclosure, this embodiment will be discussed exemplarily by taking a process of determining an illuminating manner corresponding to the current moving direction by reading a pre-stored correspondence between the direction and the illuminating manner as an example. As shown in FIG. 3, the method may include followings.

At step 301, a pre-stored correspondence between the direction and a light color and a pre-stored correspondence between the direction and a light flashing frequency are read, and a light color and a light flashing frequency corresponding to the current moving direction are determined. Alternatively, at step 301, in an example, a pre-stored correspondence between the direction and the illuminating manner including a light color and a light flashing frequency is read, and a light color and a light flashing frequency corresponding to the current moving direction are determined.

In an embodiment, based on the above embodiments, the light flashing frequency is defined besides the light color. For example, east may correspond to low-frequency flashing and red, southwest may correspond to high-frequency flashing and yellow, north may correspond to a low-frequency flashing and blue, and so on. In other words, the correspondence between the direction and the light flashing frequency is presorted, and the light color and the light flashing frequency corresponding to the current moving direction is determined based on the pre-stored correspondences.

At step 302, a current light color is adjusted to the light color determined, and an illumination is performed at the light flashing frequency determined.

In this embodiment, by implementing the above acts 301-302, the light color and the light flashing frequency corresponding to the current moving direction is determined based on the preset correspondence between the direction and the light color as well as that between the direction and the light flashing frequency, such that when the moving direction is changed, the light color and the light flashing frequency may be changed in time to prompt the user precisely and clearly, thereby avoiding going a wrong way or even getting lost.

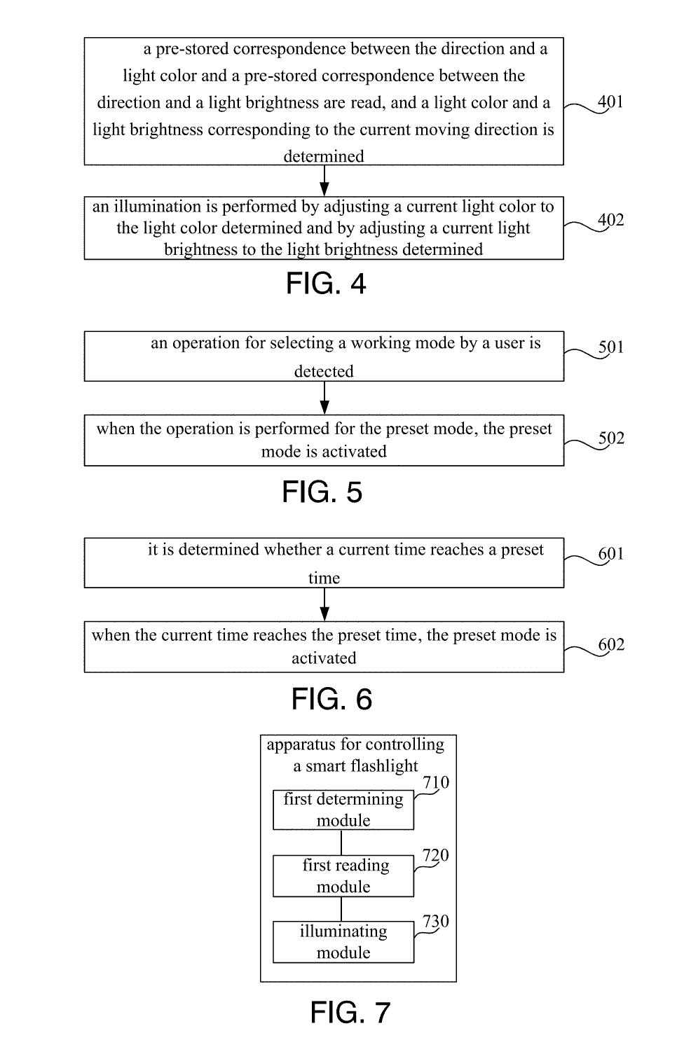

FIG. 4 is a flow chart of a method for controlling a smart flashlight according to still another example embodiment. Based on the method provided by the above embodiments of the present disclosure, this embodiment is discussed by taking a process of determining an illuminating manner corresponding to the current direction by reading a pre-stored correspondence between the direction and the illuminating manner as an example. As shown in FIG. 4, the method may include followings.

At step 401, a pre-stored correspondence between the direction and a light color and a pre-stored correspondence between the direction and a light brightness are read, and a light color and a light brightness corresponding to the current moving direction is determined. Alternatively, at step 401, in an example, a pre-stored correspondence between the direction and the illuminating manner including a light color and a light brightness is read, and a light color and a light brightness corresponding to the current moving direction is determined.

In an embodiment, the correspondence between the direction and the light color as well as that between the direction and the light brightness are pre-stored in the smart flashlight. For example, east may correspond to high-brightness red, southwest may correspond to mid-brightness yellow, north may correspond to low-brightness blue and so on. The smart flashlight is able to determine the light color and the light brightness corresponding to the current moving direction by checking the pre-stored correspondences based on the current moving direction.

At step 402, an illumination is performed by adjusting a current light color to the light color determined and by adjusting a current light brightness to the light brightness determined.

In this embodiment, by implementing the above acts 401-402, the light color and the light brightness corresponding to the current moving direction can be determined based on the preset correspondence between the direction and the light color as well as that between the direction and the light brightness, such that when the moving direction is changed, the light color and the light brightness may be changed in time to prompt the user precisely and clearly, thereby avoiding going a wrong way or even getting lost.

FIG. 5 is a flow chart of a method for controlling a smart flashlight according to yet still another example embodiment. Based on the method provided by the above embodiments of the present disclosure, this embodiment is discussed by taking a process of activating the preset mode as an example. As shown in FIG. 5, the method may include followings.

At step 501, an operation for selecting a working mode by a user is detected.

In an embodiment, there are many working modes set in the smart flashlight. For example, in a case of high light in the daytime, it may be unnecessary to start a flashlight, which may be considered as a working mode. Embodiments of the present disclosure focus on a case of low light, for example at night, this mode refers to a preset mode in the present disclosure.

At step 502, when the operation is performed for the preset mode, the preset mode is activated.

In an embodiment, a plurality of buttons may be set on the smart flashlight, corresponding to different working modes. When the operation for selecting a working mode by the user is detected and the operation corresponds to the preset mode, the preset mode is activated.

In this embodiment, by implementing the acts 501-502, the user may perform an operation for selecting a working mode to activate or activate the corresponding working mode, which is simple and convenient, thereby providing a better experience for the user.

FIG. 6 is a flow chart of a method for controlling a smart flashlight according to yet still another example embodiment. Based on the method provided by the above embodiments of the present disclosure, this embodiment is discussed by taking a process of activating the preset mode as an example. As shown in FIG. 6, the method may include followings.

At step 601, it is determined whether a current time reaches a preset time.

At step 602, when the current time reaches the preset time, the preset mode is activated.

In an embodiment, the preset time is set in the smart flashlight, which is used for determining whether to activate the preset mode. For example, in summer, the daytime is long and it is late when getting dark, such that 20:00 may be set as the preset time. Thus, if the smart flashlight determines the current date is a day in summer, and the current time is beyond the preset time, the preset mode is activated automatically.

In this embodiment, by implementing acts 601-602, the smart flashlight may determine whether the current time is beyond the preset time, when the current time is beyond the preset time, the preset time is activated automatically without any operation from the user, which is highly intelligent and automatic.

FIG. 7 is a block diagram of an apparatus for controlling a smart flashlight according to an example embodiment. As shown in FIG. 7, the apparatus may include: a first determining module 710, a first reading module 720 and an illuminating module 730.

The first determining module 710 is configured to determine a current moving direction in a preset mode.

The first reading module 720 is configured to read a pre-stored correspondence between a direction and an illuminating manner, and to determine an illuminating manner corresponding to the current moving direction determined by the first determining module 710.

The illuminating module 730 is configured to illuminate in the illuminating manner determined by the first reading module 720.

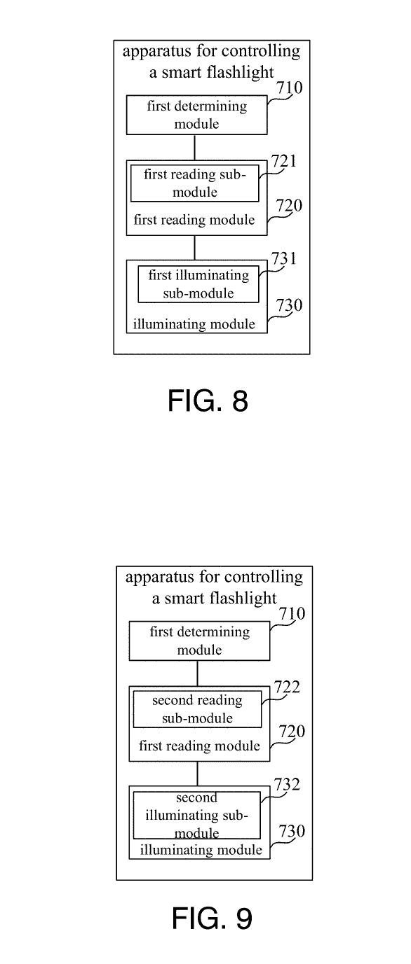

FIG. 8 is a block diagram of an apparatus for controlling a smart flashlight according to another example embodiment. As shown in FIG. 8, based on the embodiment shown in FIG. 7, in an embodiment, the first reading module 720 may include: a first reading sub-module 721, and the illuminating module 730 may include a first illuminating sub-module 731.

The first reading sub-module 721 is configured to read a pre-stored correspondence between the direction and a light color, and to determine a light color corresponding to the current moving direction.

The first illuminating sub-module 731 is configured to illuminate by adjusting a current light color to the light color determined.

FIG. 9 is a block diagram of an apparatus for controlling a smart flashlight according to yet another example embodiment. As shown in FIG. 9, based on the embodiment shown in FIG. 7, in an embodiment, the first reading module 720 may include: a second reading sub-module 722, and the illuminating module 730 may include a second illuminating sub-module 732.

The second reading sub-module 722 is configured to read a pre-stored correspondence between the direction and a light color and a pre-stored correspondence between the direction and a light flashing frequency, and to determine a light color and a light flashing frequency corresponding to the current moving direction. Alternatively, in an example, the second reading sub-module 722 is configured to read a pre-stored correspondence between the direction and the illumination manner including a light color and a light flashing frequency, and to determine a light color and a light flashing frequency corresponding to the current moving direction.

The second illuminating sub-module 732 is configured to adjust a current light color to the light color determined, and to illuminate at the light flashing frequency determined.

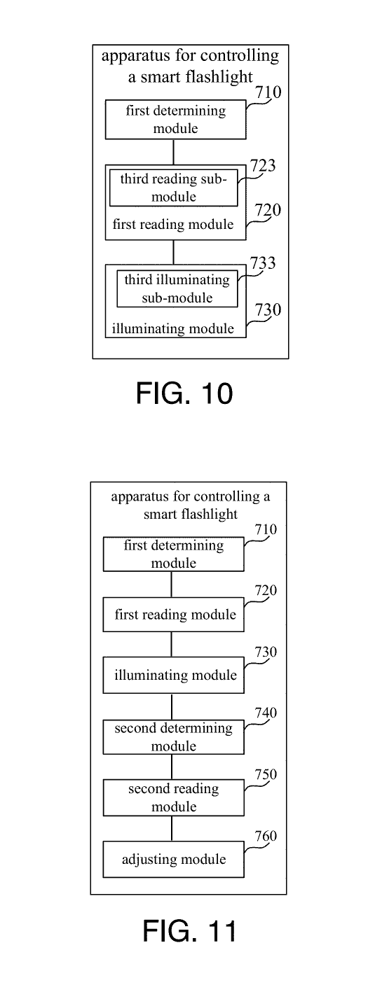

FIG. 10 is a block diagram of an apparatus for controlling a smart flashlight according to still another example embodiment. As shown in FIG. 10, based on the embodiment shown in FIG. 7, in an embodiment, the first reading module 720 may include: a third reading sub-module 723, and the illuminating module 730 may include a third illuminating sub-module 733.

The third reading sub-module 723 is configured to read a pre-stored correspondence between the direction and a light color and a pre-stored correspondence between the direction and a light brightness, and to determine a light color and a light brightness corresponding to the current moving direction. Alternatively, the third reading sub-module 723 is configured to read a pre-stored correspondence between the direction and the illumination manner including a light color and a light brightness, and to determine a light color and a light brightness corresponding to the current moving direction.

The third illuminating sub-module 733 is configured to illuminate by adjusting a current light color to the light color determined and by adjusting a current light brightness to the light brightness determined.

FIG. 11 is a block diagram of an apparatus for controlling a smart flashlight according to yet still another example embodiment. As shown in FIG. 11, based on the embodiment shown in FIG. 7, in an embodiment, the apparatus may further include a second determining module 740, a second reading module 750 and an adjusting module 760.

The second determining module 740 is configured to determine a changed direction when the current moving direction is changed.

The second reading module 750 is configured to read the pre-stored correspondence between the direction and the illuminating manner, and to determine an illuminating manner corresponding to the changed direction determined by the second determining module 740.

The adjusting module 760 is configured to adjust a current illuminating manner to the illuminating manner corresponding to the changed direction and determined by the second reading module 750.

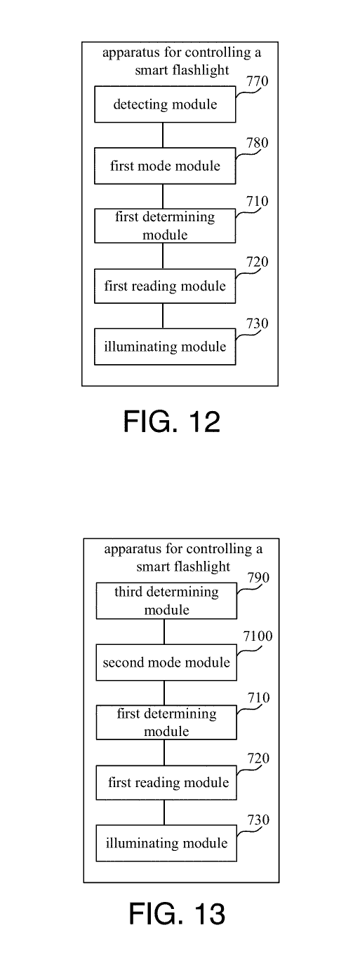

FIG. 12 is a block diagram of an apparatus for controlling a smart flashlight according to yet still another example embodiment. As shown in FIG. 12, based on the embodiment shown in FIG. 7, in an embodiment, the apparatus may further include a detecting module 770 and a first mode module 780.

The detecting module 770 is configured to detect an operation for selecting a working mode by a user.

The first mode module 780 is configured to activate the preset mode when the operation detected by the detecting module 770 is performed for the preset mode.

FIG. 13 is a block diagram of an apparatus for controlling a smart flashlight according to yet still another example embodiment. As shown in FIG. 13, based on the embodiment shown in FIG. 7, in an embodiment, the apparatus may further include a third determining module 790 and a second mode module 7100.

The third determining module 790 is configured to determine whether a current time reaches a preset time.

The second mode module 7100 is configured to activate the preset mode when the third determining module 790 determines the current time reaches the preset time.

With regard to the apparatus described in above embodiments, the specific manner in which each module executes is described in relative method embodiments, which will not be described in detail herein.

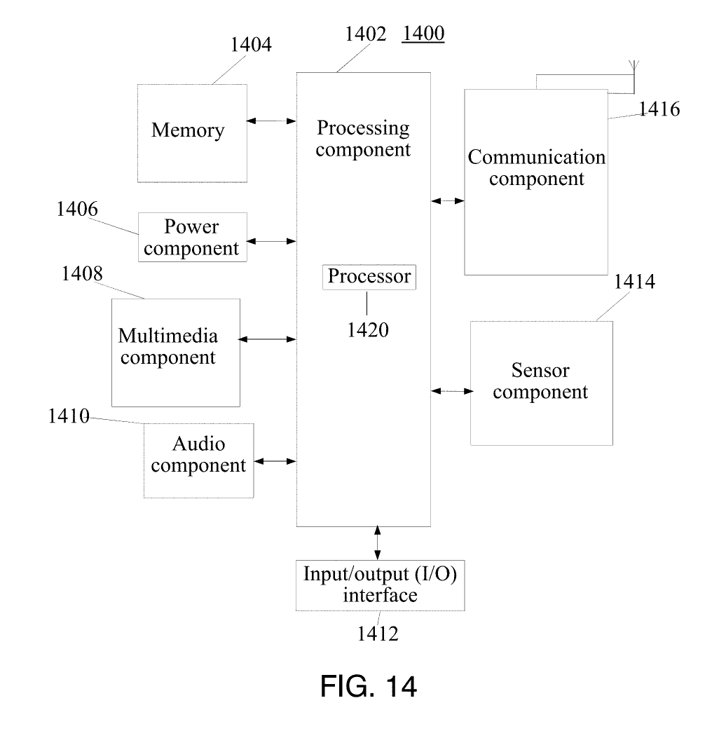

FIG. 14 is a block diagram of a control device applicable to a smart flashlight according to an example embodiment. For example, the apparatus 1400 may be a mobile phone, a computer, a digital broadcasting terminal, a message sending and receiving equipment, a game controller, a tablet device, a medical device, a fitness equipment, a personal digital assistant or the like.

Referring to FIG. 14, the apparatus 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 typically controls overall operations of the apparatus 1400, such as the operations associated with display, telephone calls, data communications, camera operations, and recording operations. The processing component 1402 may include one or more processors 1420 to execute instructions to perform all or part of the steps in the above described methods. Moreover, the processing component 1402 may include one or more modules which facilitate the interaction between the processing component 1402 and other components. For instance, the processing component 1402 may include a multimedia module to facilitate the interaction between the multimedia component 1408 and the processing component 1402.

The memory 1404 is configured to store various types of data to support the operation of the apparatus 1400. Examples of such data include instructions for any applications or methods operated on the apparatus 1400, contact data, phonebook data, messages, pictures, video, etc. The memory 1404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1406 provides power to various components of the apparatus 1400. The power component 1406 may include a power management system, one or more power sources, and any other components associated with the generation, management, and distribution of power in the apparatus 1400.

The multimedia component 1408 includes a screen providing an output interface between the apparatus 1400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1408 includes a front camera and/or a rear camera. The front camera and the rear camera may receive an external multimedia datum while the apparatus 1400 is in an operation mode, such as a photographing mode or a video mode. Each of the front camera and the rear camera may be a fixed optical lens system or have focus and optical zoom capability.

The audio component 1410 is configured to output and/or input audio signals. For example, the audio component 1410 includes a microphone (“MIC”) configured to receive an external audio signal when the apparatus 1400 is in an operation mode, such as a call mode, a recording mode, and a voice recognition mode. The received audio signal may be further stored in the memory 1404 or transmitted via the communication component 1416. In some embodiments, the audio component 1410 further includes a speaker to output audio signals.

The I/O interface 1412 provides an interface between the processing component 1402 and peripheral interface modules, such as a keyboard, a click wheel, buttons, and the like. The buttons may include, but are not limited to, a home button, a volume button, a starting button, and a locking button.

The sensor component 1414 includes one or more sensors to provide status assessments of various aspects of the apparatus 1400. For instance, the sensor component 1414 may detect an open/closed status of the apparatus 1400, relative positioning of components, e.g., the display and the keypad, of the apparatus 1400, a change in position of the apparatus 1400 or a component of the apparatus 1400, a presence or absence of user contact with the apparatus 1400, an orientation or an acceleration/deceleration of the apparatus 1400, and a change in temperature of the apparatus 1400. The sensor component 1414 may include a proximity sensor configured to detect the presence of nearby objects without any physical contact. The sensor component 1414 may also include a light sensor, such as a CMOS or CCD image sensor, for use in imaging applications. In some embodiments, the sensor component 1414 may also include an accelerometer sensor, a gyroscope sensor, a magnetic sensor, a pressure sensor, or a temperature sensor.

The communication component 1416 is configured to facilitate communication, wired or wirelessly, between the apparatus 1400 and other devices. The apparatus 1400 can access a wireless network based on a communication standard, such as WiFi, 2G or 3G or a combination thereof. In one exemplary embodiment, the communication component 1416 receives a broadcast signal or broadcast associated information from an external broadcast management system via a broadcast channel. In one exemplary embodiment, the communication component 1416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1404, executable by the processor 1420 in the apparatus 1400, for performing the above-described methods. For example, the non-transitory computer-readable storage medium may be a ROM, a RAM, a CD-ROM, a magnetic tape, a floppy disc, an optical data storage device, and the like.

The processor 1420 is configured to determine a current moving direction in a preset mode; read a pre-stored correspondence between a direction and an illuminating manner, and to determine an illuminating manner corresponding to the current moving direction; and illuminate in the illuminating manner determined.

It is noted that the various modules, sub-modules, units, and components in the present disclosure can be implemented using any suitable technology. For example, a module may be implemented using circuitry, such as an integrated circuit (IC). As another example, a module may be implemented as a processing circuit executing software instructions.

Other embodiments of the present disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method, comprising:
obtaining, by processing circuitry of a smart device, a direction signal indicative of a present moving direction of the smart device when the smart device is in a first working mode;
determining, by the processing circuitry of the smart device, a present illumination configuration corresponding to the present moving direction based on a pre-defined relationship between the moving direction and the illumination configuration; and
illuminating with the smart device according to the present illumination configuration to indicate the present moving direction.

2. The method according to claim 1, further comprising:
obtaining the pre-defined relationship that is stored in a memory of the smart device.

3. The method according to claim 1, wherein
determining the present illumination configuration corresponding to the present moving direction includes:
obtaining the pre-defined relationship between the moving direction and the illumination configuration including a light wavelength; and
determining a present light wavelength corresponding to the present moving direction based on the pre-defined relationship; and
illuminating with the smart device includes using the present light wavelength.

4. The method according to claim 1, wherein
determining the present illumination configuration corresponding to the present moving direction includes:
obtaining the pre-defined relationship between the moving direction and the illumination configuration including a light wavelength and a strobe frequency that are associated with strobe lighting; and
determining a present light wavelength and a present strobe frequency corresponding to the present moving direction based on the pre-defined relationship; and
illuminating with the smart device includes using the strobe lighting based on the present light wavelength and the present strobe frequency.

5. The method according to claim 1, wherein
determining the present illumination configuration corresponding to the present moving direction includes:
obtaining the pre-defined relationship between the moving direction and the illumination configuration including a light wavelength and a light brightness; and
determining a present light wavelength and a present light brightness corresponding to the present moving direction based on the pre-defined relationship; and
illuminating with the smart device includes using the present light wavelength and the present light brightness.

6. The method according to claim 1, further comprising:
determining a next moving direction when the moving direction is determined to deviate from the present moving direction;
determining a next illumination configuration corresponding to the next moving direction based on the pre-defined relationship between the moving direction and the illumination configuration; and
illuminating with the smart device according to the next illumination configuration.

7. The method according to 1, further comprising:
detecting an operation by a user of the smart device to select one of working modes of the smart device; and
activating the first working mode when the one of operational modes is the first working mode.

8. The method according to claim 1, further comprising:
determining, by the processing circuitry of the smart device, whether a present time associated with the smart device satisfies a preset time condition; and
when the present time satisfies the preset time condition, activating the first working mode.

9. The method according to claim 1, further comprising:
when the moving direction is determined to deviate from the present moving direction, outputting an audio signal alerting a user of the smart device of a change in the moving direction.

10. A smart device, comprising:
processing circuitry configured to:
obtain a direction signal indicative of a present moving direction of the smart device when the smart device is in a first working mode;
determine a present illumination configuration corresponding to the present moving direction based on a pre-defined relationship between the moving direction and the illumination configuration; and
illuminate with the smart device according to the present illumination configuration to indicate the present moving direction; and
a memory configured to store instructions executable by the processing circuitry.

11. The smart device according to claim 10, wherein the memory is further configured to store the pre-defined relationship.

12. The smart device according to claim 10, wherein the processing circuitry is further configured to:
obtain the pre-defined relationship between the moving direction and the illumination configuration including a light wavelength;
determine a present light wavelength corresponding to the present moving direction based on the pre-defined relationship; and
illuminate with the smart device using the present light wavelength.

13. The smart device according to claim 10, wherein the processing circuitry is further configured to:
obtain the pre-defined relationship between the moving direction and the illumination configuration including a light wavelength and a strobe frequency that are associated with strobe lighting;
determine a present light wavelength and a present strobe frequency corresponding to the present moving direction based on the pre-defined relationship; and
illuminate with the smart device using the strobe lighting based on the present light wavelength and the present strobe frequency.

14. The smart device according to claim 10, wherein the processing circuitry is further configured to:
obtain the pre-defined relationship between the moving direction and the illumination configuration including a light wavelength and a light brightness;
determine a present light wavelength and a present light brightness corresponding to the present moving direction based on the pre-defined relationship; and
illuminate with the smart device using the present light wavelength and the present light brightness.

15. The smart device according to claim 10, wherein the processing circuitry is further configured to:
determine a next moving direction when the moving direction is determined to deviate from the present moving direction;
determine a next illumination configuration corresponding to the next moving direction based on the pre-defined relationship between the moving direction and the illumination configuration; and
illuminate with the smart device according to the next illumination configuration.

16. The smart device according to claim 10, wherein the processing circuitry is further configured to:
detect an operation by a user of the smart device to select one of working modes of the smart device; and
activate the first working mode when the one of operational modes is the first working mode.

17. The smart device according to claim 10, wherein the processing circuitry is further configured to:
determine whether a present time associated with the smart device satisfies a preset time condition; and
when the present time satisfies the preset time condition, activate the first working mode.

18. The smart device according to claim 10, further configured to:
when the moving direction is determined to deviate from the present moving direction, output an audio signal alerting a user of the smart device of a change in the moving direction.

19. A non-transitory computer-readable storage medium storing a program executable by a processor to perform:
obtaining a direction signal indicative of a present moving direction of the smart device when the smart device is in a first working mode;
determining a present illumination configuration corresponding to the present moving direction based on a pre-defined relationship between the moving direction and the illumination configuration; and
illuminating with the smart device according to the present illumination configuration to indicate the present moving direction.

20. The non-transitory computer-readable storage medium according to claim 19, wherein the program when executed by the processor further performs:
detecting an operation by a user of the smart device to select one of working modes of the smart device; and
activating the first working mode when the one of operational modes is the first working mode.
